(19) United States
(12) Patent Application Publication
(10) Pub. No.: US 2004/0267634 A1
(43) Pub. Date: Dec. 30, 2004

(54) Method and system for providing management services to billboard owners and providing billboard availability data to billboard renters

(76) Inventors: Massoud Mick Mahabadi, Plymouth, MN (US); Shahram Sean Mahabadi, New Hope, MN (US); Sasan Shariaty, Plymouth, MN (US)

Correspondence Address: Roger L. Belfay, 829 Tuscarora Avenue, Saint Paul, MN, 55102, US

(21) Appl. No.: 10/876,154

(22) Filed: Jun. 24, 2004

Related U.S. Application Data
(60) Provisional application No. 60/480,904, filed on Jun. 25, 2003.

(51) Int. Cl. G06F 17/60

(52) U.S. Cl. 705/26

(57) ABSTRACT

The present invention is a method and system for providing management services to billboard owners and thereby obtaining billboard availability data to provide to billboard renters. The method comprises: obtaining billboard inventory data from the suppliers for whom business management services have been provided; providing the inventory data to the billboard renters; and purchasing the rights to use portions of the billboard inventory for the billboard renter from the billboard suppliers.

### CROSS REFERENCE TO RELATED APPLICATIONS

The application listed below is the only application related to this application. This application claims benefit of the earlier filing date under 35 USC 119(e) of provisional application No. 60/480,904 filed on Jun. 25, 2003.

The present invention is a method and system for providing management services to billboard owners and providing billboard availability data to billboard renters for use in selection and purchase of some or all of the available billboard space which meets the renters outdoor advertising needs. The method claimed provides billboard space availability data to billboard renters. Said data is obtained from billboard suppliers incidental to the broker's provision of certain business management services to the billboard suppliers. This method is implemented via the internet, but can be implemented free of the internet and even without recourse to computers.

A method and system for providing management services to billboard owners and providing billboard availability data to billboard renters.

### STATEMENT REGARDING FEDERAL SPONSORSHIP

No invention claimed in this application was made under Federally sponsored research or development.

### BACKGROUND OF INVENTION

The present invention is a method of doing business. Reliable and comprehensive data detailing the availability of billboard advertising space is essential for advertisers to assess the possibility and facilitate the implementation of advertising campaigns. There has been a long-standing need within the billboard advertising industry for reliable and comprehensive billboard availability data available to renters, which plan or place advertising campaigns. In particular the present invention provides a business method by which a broker may obtain reliable and comprehensive billboard availability data at a minimum cost by providing billboard management services to owners of billboard space at a nominal cost to the billboard owners and extracting availability data from the data used in support of the management services provided.

### BRIEF SUMMARY OF THE INVENTION

A number of business methods provide auction services for such commodities as securities, available cargo space, and general merchandise. In these applications a comprehensive data base reflecting the availability of the relevant commodity is either already existent as in the industry of cargo transport, or is inherent in the trading system, such as in the securities markets. In the outdoor advertising industry there is a need for a comprehensive database, which accurately reflects availability of outdoor advertising space for renters. The present method and system solves this problem by providing management services to outdoor billboard owners and through provision of those services obtaining a comprehensive database identifying current and future availability of outdoor advertising space. The present method exploits the availability of this data by establishing a market for renters of outdoor advertising space to purchase the available space. The purchase of available space is further facilitated by provision of search and purchase services to the renters. While the method is best realized when implemented via the Internet and its supporting computer and communications system it will be appreciated that any means of storing and transmitting the relevant data is envisioned. The importance of the comprehensiveness of the data collected makes the inclusion of outdoor advertising space renters and owners who do not have internet or computer systems a recognized and included group through provision of human interface for inventory data input services and purchase search services.

### BRIEF DESCRIPTION OF THE DRAWINGS

FIG. 1 depicts flow of information in the method and system for providing management services to billboard owners and providing billboard availability data to billboard renters

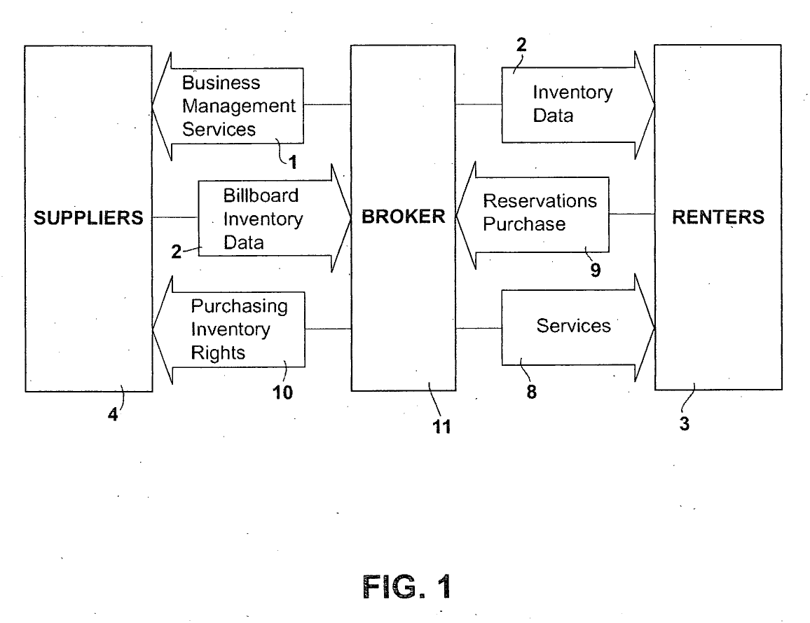

FIG. 2 is a schematic representation of the method and system for providing management services to billboard owners and providing billboard availability data to billboard renters

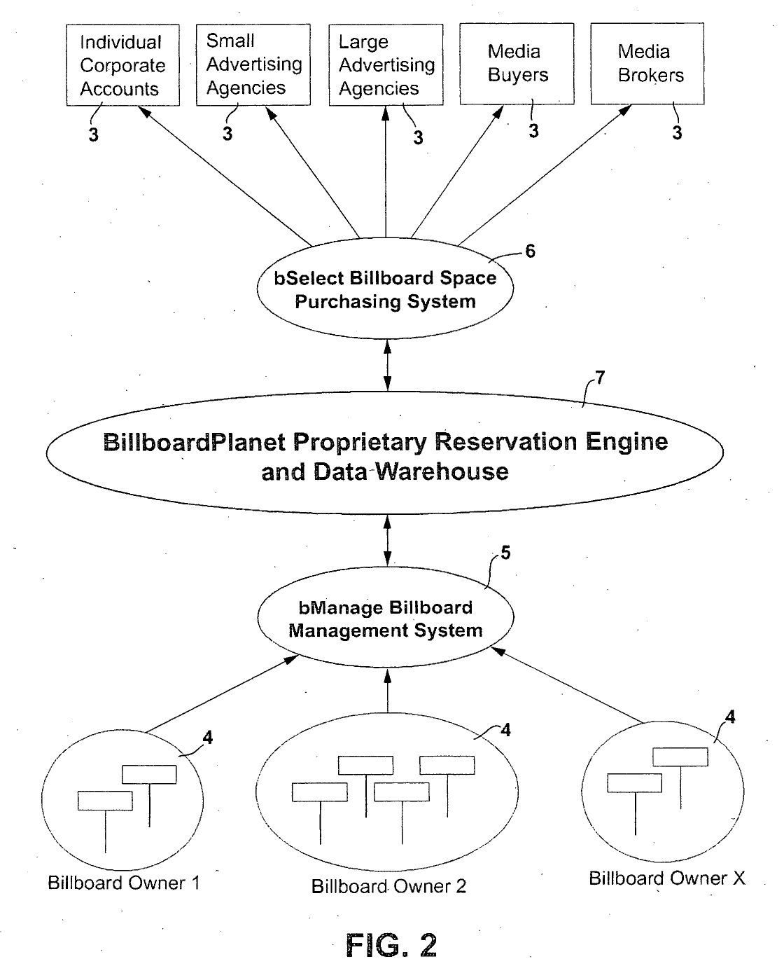

### DETAILED DESCRIPTION

The present invention is a method and system for providing billboard availability data 2 to billboard renters 3 by providing business management services 1 to billboard owners 4. The method, implemented by a broker 11 for providing, to billboard renters 3, billboard space from billboard owners, 4 comprising the steps of: providing business management services 1 to the billboard owners 4; obtaining billboard inventory data 2 from the supply of the business management services 1; providing the inventory data 2 to the billboard renters 3; and purchasing the rights to use 10 portions of the billboard inventory for the billboard renter from one or more billboard owners 4.

A billboard is any advertising mechanism or structure visible to the public from public or private places. Billboards may be standalone structures as are commonly found along public streets or on buildings. However, Billboards may also include, but are not limited to: marquees, posters, signs on buildings, signs on vehicles, and signs carried by individuals. Therefore, a billboard is any advertising media, which is capable of carrying a message, and which can be viewed by the public. A billboard owner 4 is the legal entity having the right to lease or give consent to the placement of advertising material on a billboard.

The present invention is currently implemented via the internet to provide access to the maximum number of billboard owners 4 and billboard renters 3 encompassing the maximum geographic and demographic areas. However, it will be appreciated that this method can be practiced in whole or in part without use of the internet or any computer. One objective of this method is comprehensiveness of the billboard availability data 2 available to renters 3. To further this objective the present implementation includes the ability to include billboard owners 4 and renters 3 who do not have internet or computer access by providing data entry and search services to these entities.

Although provision of billboard inventory management services to billboard providers is an important feature of this method a number of other services may be provided to encourage maximum participation by billboard owners 4 and renters 3.

The present invention is embodied in an internet based system in which billboard owner services 1 are provided by the bManage billboard management system 5, billboard renter services 8 are provided by bselect Billboard Space Purchasing System 6, and all data is stored and organized for access by Billboardplanet's Proprietary Reservation Engine and Data Warehouse 7. However, it will be recognized that Billboardplanet's proprietary reservation system and Data Warehouse are but one of a host of reservation systems and Data Warehouse tools which could be used to implement the system, which embodies the present invention.

A billboard space reservation system is provided in which available billboard space can be selected and reserved for future purchase.

Profiles for billboard space are provided to facilitate billboard space selection and subsequent reservations and purchases 9. These profiles include all information known to the broker 11 about each billboard location.

High quality digital images of billboard spaces are provided to help billboard owners 4 to determine the current content of their billboard spaces and to help billboard renters 3 to visualize their advertising at the billboard site.

Action videos showing approach views of billboard spaces are provided to allow billboard renters 3 to visualize the impact of their advertising on the viewing public. Demographic data associated with billboard spaces is provided to allow billboard renters 3 to target demographic groups to enhance the effectiveness of advertising.

Global Positioning System location of Billboard spaces is provided to facilitate location of billboards for service personnel, billboard owners 4, and billboard renters 3. Site management services are provided to facilitate obtaining and renewing of permits and leases along with similar functions such as identification of restrictions, obstructions and exceptions.

Face management services are available to billboard owners 4 including listings of service providers to remove, place and maintain signage on owner's billboards. Proof of performance imaging is provided, whereby images of implemented billboards are provided to billboard renters 3 and owners 4.

Proposal management is provided to facilitate the formation of agreements between billboard owners 4 and billboard renters 3. Proposals can be entered, edited, and responded to by billboard owners 4 and billboard renters 3.

Contract management is provided to facilitate execution and update of contracts between billboard owners 4 and billboard renters 3. Contractual items such as start dates, contract end dates, location occupancy conflicts, and installer instructions can be managed by this feature.

Vendor tracking services allows project management of outsourced work by billboard owners 4. These services include but are not limited to: installation, design, and printing.

Contact management services provide for recording of all contacts with customers and suppliers by owners 4 and renters 3 including but not limited to: names, addresses, telephone numbers, e-mail addresses, Fax numbers, contact dates, and suggested contact follow-up dates.

We claim:

1) a method for providing to billboard renters billboard space from billboard owners said method comprising the steps of:
(a) providing business management services to the billboard owners;
(b) obtaining billboard inventory data through the supply of the business management services;
(c) providing the inventory data to the billboard renters; and
(d) purchasing the rights to use portions of the billboard inventory for the billboard renter from the billboard owners.

2) The method of claim 1 further comprising the step of providing a billboard space reservation system.

3) The method of claim 1 further comprising the step of providing profile data for billboard space.

4) The method of claim 1 further comprising the step of providing high quality digital images of billboard spaces.

5) The method of claim 1 further comprising the step of providing action video of approach view of billboard spaces.

6) The method of claim 1 further comprising the step of providing demographic data associated with billboard spaces.

7) The method of claim 1 further comprising the step of providing Global Positioning System locations of billboard spaces.

8) The method of claim 1 further comprising the step of providing site management services to billboard owners.

9) The method of claim 1 further comprising the step of providing face management services to billboard owners.

10) The method of claim 1 further comprising the step of providing proof of performance imaging, whereby images of implemented billboards are available to billboard renters.

11) The method of claim 1 further comprising the step of providing proof of performance imaging, whereby images of implemented billboards are available to billboard owners.

12) The method of claim 1 further comprising the step of providing proposal management.

13) The method of claim 1 further comprising the step of providing contract management.

14) The method of claim 1 further comprising the step of providing vendor-tracking services.

15) The method of claim 1 further comprising the step of providing management of design services.

16) The method of claim 1 further comprising the step of providing management of billboard sign printing services.

17) The method of claim 1 further comprising the step of providing management of billboard installation services.

18) The method of claim 1 further comprising the step of providing contact management.
